(19) United States
(12) Patent Application Publication
(10) Pub. No.: US 2004/0241503 A1
(43) Pub. Date: Dec. 2, 2004

(54) Secondary battery

(76) Inventor: Tomio Inoue, Seto-shi (JP)

Correspondence Address: FLYNN THIEL BOUTELL & TANIS, P.C., 2026 RAMBLING ROAD, KALAMAZOO, MI, 49008-1699, US

(21) Appl. No.: 10/843,730

(22) Filed: May 12, 2004

(30) Foreign Application Priority Data
May 26, 2003 (JP) 2003-147443

(51) Int. Cl. H01M 14/00

(52) U.S. Cl. 429/5; 429/188

(57) ABSTRACT

This invention provides a secondary battery comprised of a cathode, an anode and an ion conductor wherein the ion conductor contains radioactive substance. By projecting radioactive ray upon ions and deposit in the ion conductor, valency electrons and bonding electrons in deposit are excited so as to raise chemical reaction activity of ions and deposit thereby suppressing growth and excessive expansion of crystal of the deposit. Consequently, reduction in storage capacity and electromotive force due to repeated discharge/recharge is prevented.

### BACKGROUND OF THE INVENTION

1. Field of the Invention

The present invention relates to a secondary battery which is never deteriorated even if its discharge/recharge is repeated.

2. Description of Related Art

The chemical battery is largely classified into a primary battery and a secondary battery, both of which adopt the same method of converting chemical energy to electric energy. Oxidant is used as anode activating material while reducing agent is used as cathode activating material. The both electrodes are placed in ion conductor (electrolyte water solution or non-aqueous electrolyte) such that they oppose each other and an outside load is applied to the both electrodes. Consequently, electron accepting reaction (reducing reaction) occurs at the anode and electron emitting reaction (oxidation reaction) at the cathode, so that electrons move from the cathode to the anode through the outside load. Consequently, current flows from the anode to the cathode.

Because ion moves in the ion conductor, current flows.

Discharge phenomenon is generated by electric chemical reaction and active material is consumed by discharge. A battery to be thrown away when the discharge is not induced any more is called the primary battery. A battery in which if the active material is consumed completely, electricity is supplied from outside so as to reproduce the active material, thereby ensuring repeated use thereof is called the secondary battery.

The secondary battery includes lead acid battery used in such apparatus and devices as automobiles and alkaline battery used for such small devices as electronic devices. Of the alkaline batteries, a type using lithium as the active material has attracted public attention with prevailing of portable phones and notebook type personal computer because it is the lightest and small.

The inventor of the present invention has not surveyed preceding technologies at research/development stage and patent filing stage. Therefore, he does not have any knowledge about the preceding technology which should be mentioned here.

Chemical reaction at the time of the discharge or recharge accompanies deposition or decomposition of electrolyte and if the discharge or recharge is repeated, crystal of deposited material is grown gradually and it never returns to its original state. Consequently, the capacity and electromotive force of the secondary battery drop, and therefore the battery needs to be replaced.

### SUMMARY OF THE INVENTION

In views of the above-described problem, the present invention provides a secondary battery comprised of a cathode, an anode and an ion conductor wherein the ion conductor contains radioactive substance. By projecting radioactive ray upon ions and deposit in the ion conductor, valency-electrons and bonding electrons in deposit are excited so as to raise chemical reaction activity of ions and deposit thereby suppressing growth and excessive expansion of crystal of the deposit. Consequently, the above-described problem is solved.

### DESCRIPTION OF THE PREFERRED EMBODIMENTS

Hereinafter, the embodiment of the present invention will be described in detail.

The secondary battery of the present invention is comprised of a cathode, an anode and an ion conductor and the ion conductor contains radioactive substance.

The ion conductor is so-called electrolyte which does not concern whether it is aqueous type or non-aqueous type and for example, water solution produced by dissolving inorganic electrolyte, organic electrolytic solution, polymer solid electrolyte, inorganic solid electrolyte, fused salt and the like may be used.

Active substance of both the cathode and anode may be selected appropriately depending on an ion conductor to be combined with. For example, lead and red lead, black lead and lithium containing oxide and other combinations are acceptable.

The radioactive substance may be of any type as long as it can emit an ultra small amount of radioactive ray and for example, radium, radon and the like can be mentioned. As for its configuration, the radioactive substance is preferred to be fine powders in order to secure an excellent dispersibility in the ion conductor.

Next, an operation of the secondary battery will be described.

Radioactive substance in the ion conductor always emits radioactive ray that is extremely small in amount and harmless to the human body, and when ions in the ion conductor receive this radioactive ray, valency electrons are transited to excitation state so that chemical reaction becomes likely to occur.

Therefore, generation velocity of deposit due to chemical reaction upon discharge is fast and therefore, crystal growth is suppressed, so that crystal is never expanded too much.

Further, the generated deposit is decomposed easily by exchange of electrons because bonding electron is excited due to reception of radioactive ray.

In conclusion, because the secondary battery of the present invention is comprised of the cathode, anode and ion conductor and the ion conductor contains radioactive substance, activities of ion and deposit in the ion conductor are raised by radioactive ray, so that reversible reaction of active substance and electrolyte can be, made smooth. Consequently, the same secondary battery can be used semi-permanently without any drop in storage capacity and electromotive force and therefore, its practical effect is very large.

What is claimed is:

1. A secondary battery comprised of a cathode, an anode and an ion conductor wherein said ion conductor contains radioactive substance.
